(19) United States
(12) Patent Application Publication
(10) Pub. No.: US 2002/0072254 A1
(43) Pub. Date: Jun. 13, 2002

(54) Electrical device having connecting shaft assembly

(76) Inventor: Chien-Yi Yang, Taipei (TW)

Correspondence Address: JACOBSON HOLMAN PLLC, 400 SEVENTH STREET N.W., SUITE 600, WASHINGTON, DC, 20004, US

(21) Appl. No.: 09/880,756

(22) Filed: Jun. 15, 2001

(30) Foreign Application Priority Data
Dec. 8, 2000 (TW) 89221301

(51) Int. Cl. H01R 39/00

(52) U.S. Cl. 439/31

(57) ABSTRACT

A connecting shaft assembly used between first and second halves of an electronic device, comprises a bracket defining first and second end portions opposite to each other. A pair of first shaft members spaced from one another extends outward from the first end portion; and a pair of second shaft members spaced from one another extends from the second end portion. An electrical device configured by first and second halves pivotally and electrically coupled by the connecting shaft assembly.

### BACKGROUND OF THE INVENTION

1. Field of the Invention

The present invention relates to an electrical device, and more particularly to an electrical device having connecting shaft assembly for facilitating easy folding and unfolding operation while providing robust electrical connections between two halves.

2. Description of the Prior Art

Electrical devices, such as palmtop, notebook, WAP mobile phone, electronic dictionary, electronic translator, DVD, MD player have become a part of our daily life. Those devices can be easily logged on Internet through wire/wireless communication systems. As a result, the user can easily access video/audio information immediately by those electronic devices while have display. However, even countless efforts have been taken in reducing the dimension of those electronic devices, each electronic device has a certain limit of its dimension which makes those electronic devices to be inconvenient to carrying or being portable.

One of the approaches it to make the electronic device with first and second halves electrically coupled together. The first half can unfold with respect to the second half during usage, while the first half can fold onto the second half when the device is not in use. Accordingly, the electronic device features a compact dimension when it is not in use.

In order to make the first and second halves foldable and workable, electrical connections between first and second halves are extremely critical to the device. Conventionally, the first and second halves are coupled by a hollow shaft arranged between the first and second halves. Connecting wires are arranged within the hollow shaft to make electrical connections between the first and second halves. Nevertheless, the conventionally hollow shaft has foreseeable defects, such as the shaft projects over a plane defined by the first and second halves, such as shown in FIG. 1. Not only will the projected shaft impair the operation of the electronic device, but also will negate the appearance of the electronic device. In addition, since the connecting wires are arranged within the hollow shaft, inadequate wearing, short-circuit may happen after a period of usage.

### SUMMARY OF THE INVENTION

It is an objective of this invention to provide a connecting shaft assembly in which conventional defects can be properly solved.

In order to achieve the object set forth, a connecting shaft assembly used between first and second halves of an electronic device in accordance with the present invention comprises a bracket defining first and second end portions opposite to each other. A pair of first shaft members spaced from one another extends outward from the first end portion; and a pair of second shaft members spaced from one another extends from the second end portion. An electrical device configured by first and second halves pivotally and electrically coupled by the connecting shaft assembly.

### BRIEF DESCRIPTION OF DRAWINGS

The accomplishment of the above-mentioned object of the present invention will become apparent from the following description and its accompanying drawings which disclose illustrative an embodiment of the present invention, and are as follows:

FIG. 1 is an end view of a prior art connecting shaft in connecting first and second halves of an electrical device;

FIG. 2 is a top view of FIG. 1;

FIG. 3 is an end view of a connecting shaft assembly in accordance with the present invention for electrically coupling first and second halves of an electrical device;

FIG. 4 is an end view of the connecting shaft assembly of FIG. 3;

FIG. 5 is a is a top view of FIG. 4;

FIG. 6 is a side view of FIG. 4;

FIG. 7 is an end view of the electrical device in which first and second halves are folded;

FIG. 8 is a end view showing the first half is positioned with respect to the second half;

FIG. 9 is similar to FIG. 8 with the first half positioned in a slant position.

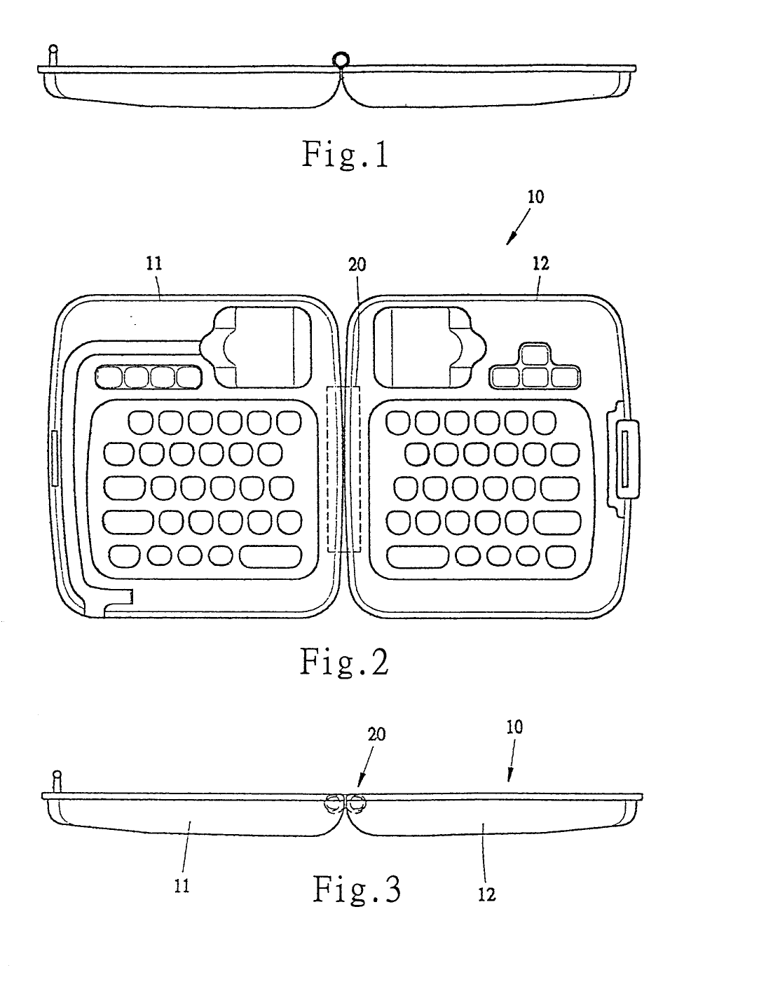

### DESCRIPTION OF PREFERRED EMBODIMENT

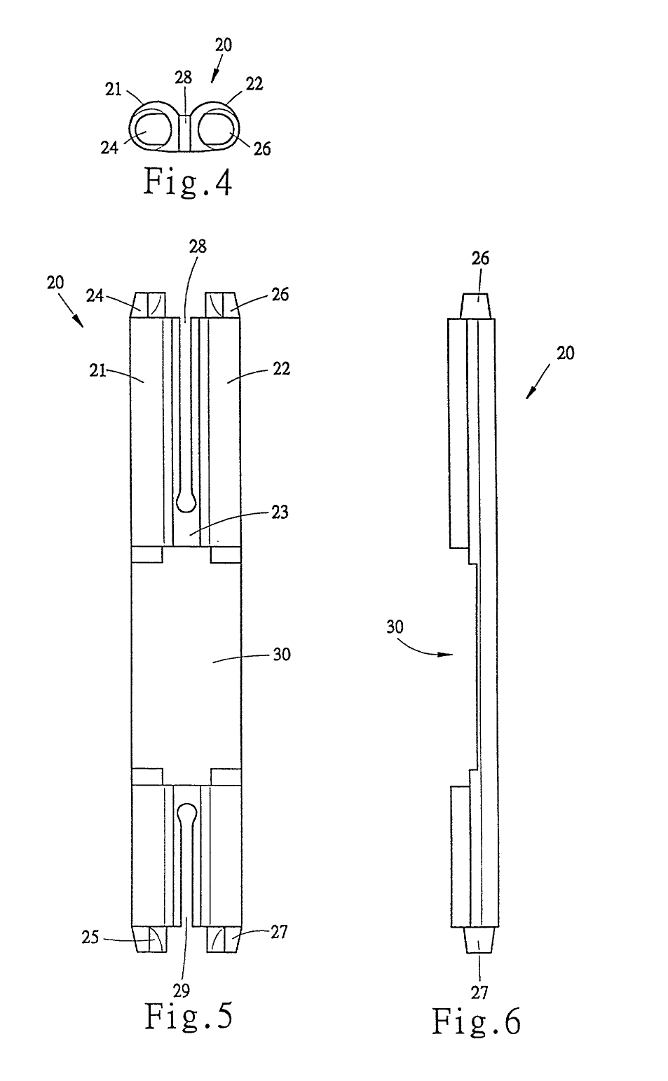

Referring to FIGS. 4, 5, and 6, a connecting shaft assembly 20 includes a first shaft 21 and second shaft 22 extend along sides of a bracket 30. The thickness of the bracket 30 is smaller to diameter of the first and second shafts 21, 22. The first and second shafts 21, 22 are further connected by a web portion 23 in an area adjacent to junction between the shafts 21, 22 and the bracket 30. The bracket 30 is configured such that a flat flexible cable (not shown) can extend therethrough thereby facilitating electrical connection between first and second halves 11, 12 of the electrical device 10. The flat flexible cable can be simply covered with a protective layer. As a result, the overall assembling procedures are simplified.

The first and second halves 11, 12 can pivotally attached to first and second shafts 21, 22, respectively. As a result, the first and second halves 11, 12 can be relatively positioned with each other for easy operation.

The first and second shafts 21, 22 further include tapered ends 24, 25, and 26, 27, respectively for easy attachment with the first and second halves 11, 12 of the electrical device 10.

The first and second shafts 21, 22 are spaced with upper and lower gaps 28, 29 such that the first and second shafts 21, 22 are provided with resilience. In addition, a length of the gaps 28, 29 are also variable for different applications. As shown in FIG. 5, the gaps 28, 29 have different length.

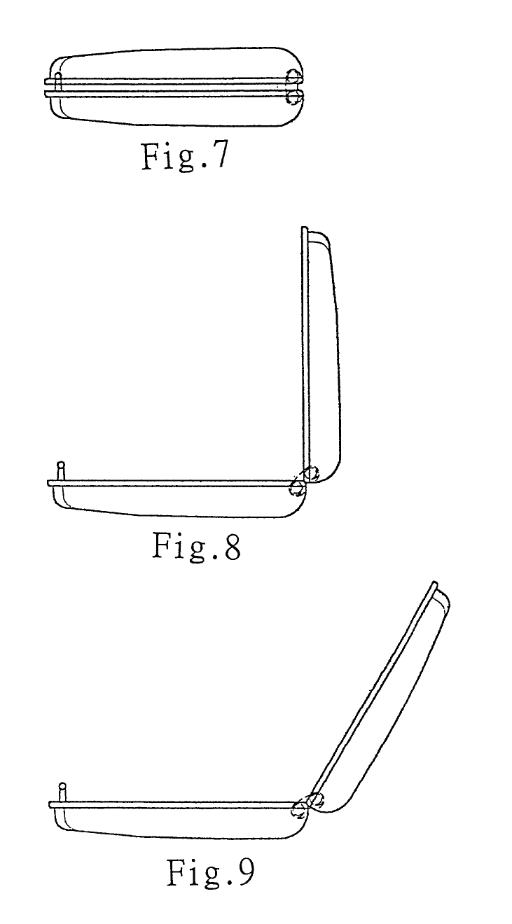

As shown in FIGS. 7, 8, and 9, when the connecting shaft assembly 20 is assembled to the electrical device 10 with the first and second halves 11, 12 pivotally and tightly assembled within the first and second shafts 21, 22, respectively. By this arrangement, the first half 11 may rotate as centered on the first shaft 21, while the second half 12 may rotate as centered on the second shaft 22. In addition, since the first and second shafts 21, 22 are provided with resilience by the provision of the gaps 28, 29, the first and second halves 11, 12 can be positioned any angle within 180 degrees. As a result, the electrical device 10 becomes more user friendly.

It will be understood that the invention may be embodied in other specific forms without departing from the spirit or central characteristics thereof. The present example and embodiment, therefore, is to be considered in all respects as illustrative and not restrictive, and the invention is not to be limited to the details given herein.

We claim:

1. A connecting shaft assembly used between first and second halves of an electronic device, comprising
a bracket defining first and second side portions opposite to each other;
a first shaft member extending from said first side portion; and
a second shaft member extending from said second end portion and spaced with said first shaft member.

2. The connecting shaft assembly as recited in claim 1, wherein said bracket has a thickness which is smaller than a diameter of said first and second shaft members.

3. The connecting shaft assembly as recited in claim 1, wherein said first and shaft members are connected by a web portion located adjacent to said bracket.

4. An electronic device, comprising
a first half,
a second half; and
a connecting shaft assembly arranged between said first and second halves such that said first half is pivotally moveable with respect to said second half, including first and second shaft members resiliently spaced from each other, said connecting shaft assembly further including a flattened portion.

5. The electronic device as recited in claim 4, wherein said flattened portion has a thickness smaller than diameters of said first and second shaft members.
